(19) United States
(12) Patent Application Publication
(10) Pub. No.: US 2010/0138231 A1
(43) Pub. Date: Jun. 3, 2010

(54) SYSTEMS AND METHODS FOR CLINICAL ELEMENT EXTRACTION, HOLDING, AND TRANSMISSION IN A WIDGET-BASED APPLICATION

(76) Inventors: Steven E. Linthicum, Lake in the Hills, IL (US); Steven L. Fors, Chicago, IL (US); Anthony L. Ricamato, West Chicago, IL (US); Eric T. Jester, Hoffman Estates, IL (US); Ryan W. Gross, Chicago, IL (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/393,698

(22) Filed: Feb. 26, 2009

Related U.S. Application Data
(60) Provisional application No. 61/118,655, filed on Nov. 30, 2008.

(51) Int. Cl. G06Q 50/00; G06F 15/16; G06F 3/048

(52) U.S. Cl. 705/2; 709/202; 709/206; 715/764

(57) ABSTRACT

Certain example embodiments provide systems and methods for providing clinical element extraction, holding, and transmission in a widget-based application. An example clinical data element communicator system includes a user interface including clinical content retrieved from a plurality of clinical information sources for graphical display to a user. The user interface facilitates user interaction with the displayed clinical content, the clinical content including applications and patient data. The example system also includes a holding area for clinical content and a transmission unit for transmitting the clinical content to one or more recipients. The holding area is displayed as part of the user interface and holds clinical content selected by the user and deposited in the holding area. The clinical element transmission unit receives the clinical content deposited in the holding area, packages the clinical content, and transmits the clinical content in an electronic data message to one or more recipients.

### RELATED APPLICATIONS

The present application claims the benefit of priority to U.S. Provisional Patent Application No. 61/118,655, filed on Nov. 30, 2008, entitled “SYSTEMS AND METHODS FOR CLINICAL ELEMENT EXTRACTION, HOLDING, AND TRANSMISSION IN A WIDGET-BASED APPLICATION”, which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during and/or after surgery, medical personnel may access patient information, such as images of a patient's anatomy, that are stored in a medical information system. Radiologist and/or other clinicians may review stored images and/or other information, for example.

Using a PACS and/or other workstation, a clinician, such as a radiologist, may perform a variety of activities, such as an image reading, to facilitate a clinical workflow. A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Current PACS and/or other reviewing systems provide all available medical information on a screen for a user. However, this information is not organized. In addition, there is currently no way to tell the user which of these data elements are important and which are not. Simply browsing through data is quite problematic as it is a huge disruption in a physician's workflow and often fails to yield the desired end user results.

A variety of clinical data and medical documentation is available throughout various clinical information systems, but it is currently difficult to find, organize, and effectively present the information to physicians and other healthcare providers at a point of care. There are a myriad of difficulties associated with this task. Current systems and methods perform static queries on single data sources, which generally returns information which may or may not be relevant and is typically incomplete.

Based on recent studies, computerized physician order entry errors have increased in approximately the last five years. According to the Journal of the American Medical Informatics Association in 2006, unintended adverse consequences from computer entry errors fell into nine major categories (in order of decreasing frequency): 1) more/new work for clinicians, 2) unfavorable workflow issues, 3) never-ending system demands, 4) problems related to paper persistence, 5) untoward changes in communication patterns and practices, 6) negative emotions, 7) generation of new kinds of errors, 8) unexpected changes in the power structure, and 9) and overdependence on technology. Poor usability and user interface design contributes to most if not all of these categories.

### BRIEF SUMMARY OF THE INVENTION

Certain example embodiments of the present invention provide systems and methods for providing clinical element extraction, holding, and transmission in a widget-based application.

Certain examples provide systems and methods for providing adaptive, work-centered healthcare services via an adaptive user interface. An example clinical data element communicator system includes a user interface including clinical content retrieved from a plurality of clinical information sources for graphical display to a user. The user interface facilitates user interaction with the displayed clinical content, the clinical content including applications and patient data. The example system also includes a holding area for clinical content and a transmission unit for transmitting the clinical content to one or more recipients. The holding area is displayed as part of the user interface and holds clinical content selected by the user and deposited in the holding area. The clinical element transmission unit receives the clinical content deposited in the holding area, packages the clinical content, and transmits the clinical content in an electronic data message to one or more recipients.

An example method for clinical data element communication includes accepting user input to select clinical content retrieved from a plurality of clinical information sources and graphically displayed to a user, the displayed clinical content including clinical applications and patient data. The example method also includes temporarily storing clinical content selected by the user and deposited in a holding area displayed as part of the user interface. The example method further includes generating an electronic data message including the clinical content temporarily stored from the holding area. Additionally, the example method includes transmitting the electronic data message to one or more recipients.

An example computer readable medium includes a set of instructions for execution on a computer which, when executed, implement a data element communicator system. The system implemented by the set of instructions includes a user interface including electronic data elements retrieved from a plurality of information sources for graphical display to a user. The user interface facilitates user interaction with the displayed electronic data elements. The system also includes a holding area displayed as part of the user interface. The holding area holds one or more electronic data elements selected by the user and deposited in the holding area. The system further includes a data element transmission unit receiving the one or more electronic data elements deposited in the holding area, packaging the one or more electronic data elements, and transmitting the one or more electronic data elements in an electronic data message to one or more recipients.

### BRIEF DESCRIPTION OF SEVERAL VIEWS OF THE DRAWINGS

FIG. 1 illustrates a workflow for providing adaptive, work-centered healthcare services in accordance with certain embodiments of the present invention.

FIG. 2 shows an example adaptive user interface in accordance with an embodiment of the present invention.

FIG. 3 depicts an example mobile device including a user interface, such as the user interface described in relation to FIG. 2.

FIG. 4 illustrates an example use case of an adaptive, work-centered user interface in perinatal care in accordance with an embodiment of the present invention.

FIG. 5 depicts a user interface architecture in accordance with certain embodiments of the present invention.

FIG. 6 depicts an example adaptive user interface system including active listening and response capability in accordance with an embodiment of the present invention.

FIG. 7 shows a flow diagram for a method for access to health content via an adaptive, work-centered user interface and supporting architecture in accordance with certain embodiments of the present invention.

FIG. 8 shows an example holding area and associated tool allowing for selection of one or more clinical elements, holding of the selected element(s), and transmission of the selected clinical element(s) to one or more recipients in accordance with certain embodiments of the present invention.

FIG. 9 shows an example message received by a recipient including expanded detail regarding selected clinical elements selected by the user via the tool of FIG. 8 in accordance with certain embodiments of the present invention.

FIG. 10 illustrates an example widget system facilitating selection, holding, and transmission of one or more clinical elements from one or more applications or widgets to one or more recipients in accordance with certain embodiments of the present invention.

FIG. 11 illustrates a flow diagram for a method for facilitating selection, holding, and transmission of one or more clinical elements from one or more applications or widgets to one or more recipients in accordance with certain embodiments of the present invention.

FIG. 12 shows a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide access by an end user to information across enterprise systems. Certain embodiments provide a search-driven, role-based, workflow-based, and/or disease-based interface that allows the end user to access, input, and search medical information seamlessly across a healthcare network. Certain embodiments offer adaptive user interface capabilities through a work-centered interface tailored to individual needs and responsive to changes in a work domain. Certain embodiments introduce an adaptive, work-centered user interface technology software architecture, which embodies two novel concepts. The first concept is to use an ontology modeling approach to characterize a work domain in terms of “work-centered” activities as well as computation mechanisms to achieve an implementation that supports those activities. The second concept is to provide adaptive interaction, both user directed and automated, in work-centered characterization and presentation mechanisms of the user interface to enterprise-level applications.

Healthcare information systems are most effective when users are able to find and make use of relevant information across a timeline of patient care. An adaptive user interface can leverage semantic technology to model domain concepts, user roles and tasks, and information relationships, for example. Semantic models enable applications to find, organize and present information to users more effectively based on contextual information about the user and task. Applications can be composed from libraries of information widgets to display multi-content and multi-media information. In addition, the framework enables users to tailor the layout of the widgets and interact with the underlying data.

In an example, a new level of adaptive user interface design is achieved by taking advantage of semantic Web technology. Domain concepts and relationships are characterized in a hierarchy of ontologies, associated with upper level ontological constructs that enable adaptive reasoning and extensibility.

Thus, certain embodiments offer adaptive user interface capabilities through use of a controller that can “reason” about metadata in an ontology to present users with a work-centered application tailored to individual needs and responsive to changes in a work domain. Targeted information can be delivered from “external” data in an application context-sensitive manner

In human-computer interaction, user interface data, events, and frequencies can be displayed, recorded, and organized into episodes. By computing data positioning on the screen, episode frequencies, and implication relations, certain example embodiments can automatically derive application-specific episode associations and therefore enable an application interface to adaptively provide just-in-time assistance to a user. By identifying issues related to designing an adaptive user interface, including interaction tracking, episodes identification, user pattern recognition, user intention prediction, and user profile update, an interface is generated that can act on a user's behalf to interact with an application based on certain recognized plans. To adapt to different users' needs, the interface can personalize its assistance by learning user profiles and disease-specific workflows, for example.

In certain embodiments, an adaptive user interface system includes a search engine, a Web server, an active listener, an information composition engine, a query engine, a data aggregator, a document summarizer, a profile context manager, and clinical and administrative dashboards, for example. Certain embodiments offer a complete view of an entire patient medical record in a user-specific, role-specific, disease-specific manner. In certain embodiments, a user interface can also be configured to provide operation views of data, financial views of data, and also serve as a dashboard for any type of data aggregation.

Certain embodiments provide an adaptive, work-centered user interface technology software architecture. The architecture uses an ontology modeling approach to characterize a work domain in terms of “work-centered” activities as well as computation mechanisms that achieve an implementation supporting those activities. The architecture also provides adaptive interaction, both user directed and automated, in the work-centered characterization and presentation mechanisms of the user interface to enterprise-level applications.

A work-centered solution helps provide an integrated and tailored system that offers support to work in a flexible and adaptable manner by customizing user interaction according to the situated context in which work is accomplished. Under a work-centered approach, an understanding of the overall targeted work domain is developed. For example, questions used to develop an understanding of the work domain can include what the work domain encompasses, what the goals of work are, who participates in the work domain, and how the participants achieve the goals of the work domain, given a local context. The understanding of the work domain can be used to characterize and, thus, support participants' day-to-day activities.

In certain embodiments, an active listener agent operates in a foreground and/or background of a computing device and/or software application, such as a user interface, to monitor user and program activity. For example, the active listener agent can gather information related to widgets in a user interface. The active listener agent can gather information related to actions generated by a user with respect to the user interface and its content, for example.

In certain embodiments, based on application (e.g., widget) information and user interaction, the active listener agent can identify information and/or functionality important to a user based on a current context. In an embodiment, if the active listener agent detects that one or more data elements displayed on a user interface reach a predetermined threshold, the active listener automatically places one or more widgets on the user interface that include additional relevant information to help enable the user to make a well-informed decision. In another embodiment, the active listener agent can help the user by reacting to the user's interaction with an application and provide additional insight by displaying additional information in the form of widget(s) and/or other information on a displayed user interface as a result of the user's actions. For example, if the user drags a certain data element from one widget to another widget (e.g., via cursor selection of the element and movement across a displayed interface using a mousing device), the active listener agent can reposition (e.g., size and/or location) that information on the displayed interface so that an arrangement of data elements signifies a different level of information useful in helping the user arrive at a conclusion (e.g., regarding diagnosis and/or treatment of a patient). The active listener agent can then either place a pre-made relevant widget on the interface that could be helpful a the particular scenario and/or can create a new widget based on the content of the widget the user changed in addition to the data context on the user interface.

Rather than focus on pre-determined workflows, the active listener provides a user with additional information helpful to the user in certain situations where there is no known workflow or protocol. Based on historical data and/or other input, the system displays additional information and/or functionality to the user that is relevant to the user to make an informed decision. In the background of an application and/or interface, for example, the active listener can monitor activity of data elements on a displayed interface. When these data elements reach a certain threshold, the active listener places additional information on the displayed interface to help the user make an informed decision. Alternatively or additionally, the active listener can detect when the user makes a change to an application (e.g., by dragging and dropping a data element from on widget to another widget, by conducting a search, by changing a diagnosis, etc.). By combining a context of user interaction with displayed user interface content, relevant information and/or functionality can be provided to a user, for example.

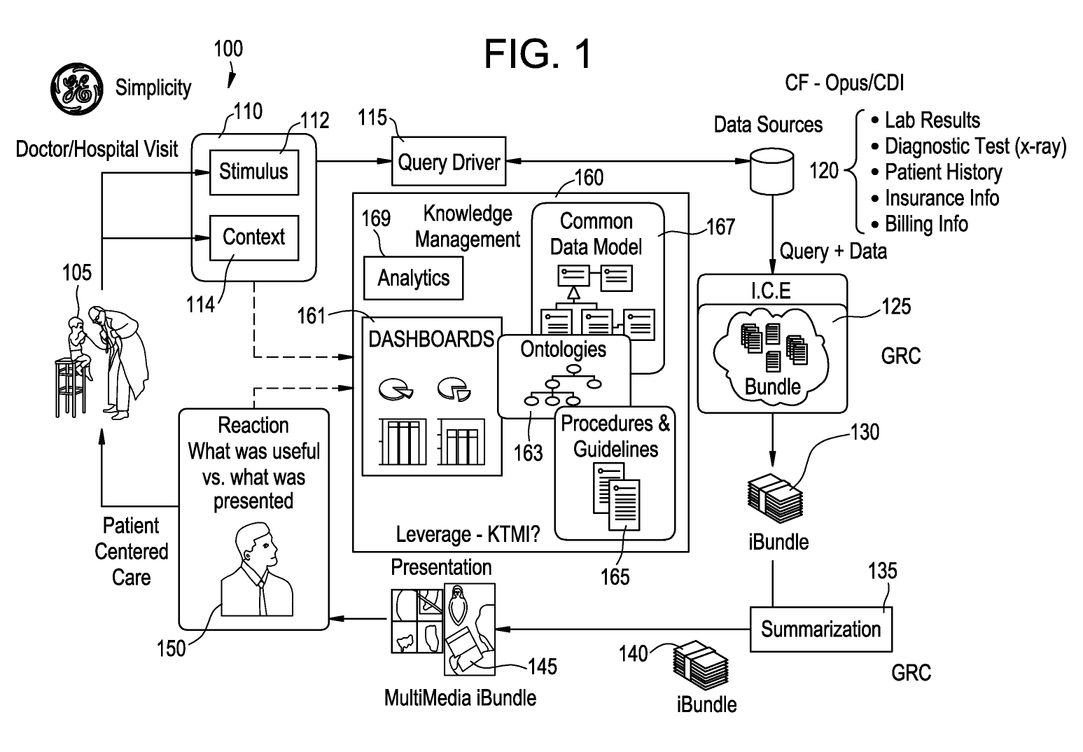

FIG. 1 illustrates a workflow 100 for providing adaptive, work-centered healthcare services in accordance with certain embodiments of the present invention. The workflow 100 includes a patient visit 105 to a doctor, hospital, clinic, etc. From the patient visit 105, a query 110 is generated by a clinician such as an examining physician, a nurse, etc. The query 110 can include a stimulus 112 observed and a patient context 114, for example. The query 110 is passed to a query driver 115. The query driver 115 can query one or more data source 120 and/or a knowledge management subsystem 160, for example. Data source(s) 120 can include one or more of lab results, diagnostic tests (e.g., x-ray, magnetic resonance image, ultrasound, etc.), patient history, insurance information, billing information, etc.

In certain embodiments, the query driver 115 can include and/or be in communication with a Query Enhancement Engine (“QUEEN”). Information may be represented in a plurality of formats including text (e.g., reports and papers), tables (e.g., databases), images (e.g., x-ray and computed tomography scans), and video (e.g., surgical procedures). Furthermore, information often reside on different systems and are stored and/or computed in a heterogeneous environment.

The Query Enhancement Engine can be used for retrieving information from disparate information sources 120 based on an information need (e.g., a stimulus 112) and a context 114. First, based on the original query 110 and context 114, QUEEN determines which information source(s) 120 are most appropriate for retrieving the requested information by consulting an information registry.

Once candidate information source(s) 120 have been identified, the query 110 is generated (by the Query Enhancement Engine 115) and passed to the information source 120 for retrieval. Different data repositories (file systems, databases, etc) utilize different mechanisms for retrieving data within them. The information source 120 encapsulates these retrieval mechanisms.

To improve the precision of retrieval results, it is sometimes beneficial to modify the query prior to retrieval. Query enhancement may involve adding additional terms to a query to improve results. Query refinement may involve removing or substituting terms to a query to improve performance. QUEEN 115 may request information using an initial query and then enhance or refine the query to improve performance, for example.

The query 110 is combined with data from the one or more data source 120 and provided to an information composition engine (“ICE”) 125 to compile or bundle data from the data source(s) 120 in response to the query 110. The ICE 125 can bundle information for presentation from multiple, heterogenous data sources 120.

For example, for a given information need, several different types of information may be desirable for the particular task at hand to form a semantically meaningful bundle of information. A bundle includes one or more types of information (e.g., patient history and lab results). Organizing the various informational items into semantic units is referred to as information composition or bundling. The ICE 125 is responsible for composing the retrieved information from the data source(s) 120 together into a bundle that is meaningful to the user. Bundles may be composed based on the semantic needs of the user, and may also be driven by user preferences, and/or other knowledge appropriate to the domain, for example.

In certain embodiments, the ICE 125 uses Composers to compose the information retrieved from the data source(s) 120. Composers employ Composition Decision Logic (“CDL”), for example, to compose the information. Some examples of CDL include aggregation elimination of redundant information, lightweight summarization of information, and fusion of results, for example.

A controller, including an active listener component, for example, can manage the interaction between the QUEEN 115 and the ICE 125. When the QUEEN 115 has retrieved the information, the information is passed to the ICE 125 for composition and bundling before being delivered to the application or user. The active listener component can monitor and react to information retrieved by the QUEEN 115 and passed to the ICE 125, for example.

During composition, it may be determined that some information is missing or insufficient. In this case, the ICE 125 can inform the controller that information is missing/insufficient. The controller can then inform the Query Engine 115 that one or more queries 110 are to be enhanced or refined in order to improve retrieval performance. The query(ies) 110 are performed again and the results are passed back to the ICE 125 for composition and bundling prior to being returned to the user, for example.

The ICE 125 then produces a bundle 130 including relevant information composed and tailored for a requesting user based on context information 114 from the query 110. The bundle 130 is passed to the summarization engine 135. The summarization engine 135 provides multi-document summarization for the content of the bundle 130. Summarization will be described further below.

A revised bundle 140, annotated with summaries from the summarization engine 135, is used to generate a presentation 145. The presentation can include a multimedia bundle of text, video and images returned from a metadata search of the data source(s) 120 and including contextual summaries from the summarization engine 135. A user can drill down into details through the presentation 145. A user, such as a physician and/or nurse, can use information from the presentation 145 to further diagnose and/or treat the patient. A user's reaction and/or other feedback 150 from the presentation 145 information can be provided back to the knowledge management subsystem 160 for subsequent use. In certain embodiments, an active listener component to the knowledge management subsystem 160 updates and/or provides additional content and/or application based on the user reaction/feedback 150, for example.

The knowledge management subsystem 160 will now be described in further detail. The knowledge management subsystem 160 includes one or more tools and/or additional information to assist the query driver 115 to form a query to extract relevant information from the data source(s) 120. Query 110 information, such as stimulus 112 and context 114, can be input to the knowledge management subsystem 160 to provide relevant tools and/or information for the query driver 115. Alternatively and/or in addition, clinician reaction and/or other feedback 150 can be fed back into the subsystem 160 to provide further information and/or improve further results from the knowledge management subsystem 160.

As shown, for example, in FIG. 1, the knowledge management subsystem 160 includes one or more dashboards 161, one or more ontologies 163, procedures and guidelines 165, a common data model 167, and analytics 169. The knowledge management subsystem 160 can provide a Knowledge and Terminology Management Infrastructure (“KTMI”) to the workflow 100. An ontology 163 details a formal representation of a set of concepts within a domain and the relationships between those concepts. The ontology 163 can be used to define a domain and evaluate properties of that domain. The common data model 167 defines relationships between disparate data entities within a particular environment and establishes a context within which the data entities have meaning. The common data model 167 provides a data model that spans applications and data sources in the workflow 100 and defines data relationships and meanings within the workflow 100. Using the analytics 169, for example, the subsystem 160 can access dashboard(s) content 161, ontology(ies) 163, and procedures/guidelines 165 based on a common data model 167 to provide output to the query driver 115.

The activity of summarization engine 135 will now be described in further detail. Multi-document summarization is an automatic procedure aimed at extraction of information from multiple texts written about the same topic (e.g., disease across multiple patients). A resulting summary report allows individual users, such as examining physicians, nurses, etc., to quickly familiarize themselves with information included in a large cluster of documents. Thus, the summarization engine 135 can complement the ICE 125 to summarize and annotate content for ease of reference, for example.

Multi-document summarization creates information reports that are more concise and comprehensive than a review of the raw data. Different opinions are put together and outlined to describe topics from multiple perspectives within a single document. While a goal of a brief summary is to simplify an information search and reduce time by pointing to the most relevant source documents, a comprehensive multi-document summary should itself contain the requested information, hence limiting the need for accessing original files to cases when refinement is required. Automatic summaries present information extracted from multiple sources algorithmically, without any editorial touch or subjective human intervention, in an attempt to provide unbiased results.

However, multi-document summarization is often more complex than summarizing a single document due to thematic diversity within a large set of documents. A summarization technology aims to combine the main document themes with completeness, readability, and conciseness. For example, evaluation criteria for multi-document summarization developed through Document Understanding Conferences, conducted annually by the National Institute of Standards and Technology, can be used.

In certain embodiments, the summarization engine 135 does not simply shorten source texts but presents information organized around key aspects of the source texts to represent a wider diversity of views on a given topic. When such quality is achieved, an automatic multi-document summary can be used more like an overview of a given topic.

Multi-document summary criteria can include one or more of the following: a clear structure, including an outline of the main content, from which it is easy to navigate to full text sections; text within sections is divided into meaningful paragraphs; a gradual transition from more general to more specific thematic aspects; good readability; etc. with respect to good readability, the automatic overview can show, for example, no paper-unrelated “information noise” from the respective documents (e.g., web pages); no dangling references to subject matter not mentioned or explained in the overview; no text breaks across a sentence; no semantic redundancy; etc.

In certain embodiments, a summarization approach includes three steps: 1) segmentation, 2) clustering/classification, and 3) summary generation. An initial text segmentation is performed by dividing or “chunking” a document into paragraphs based on existing paragraph boundaries. Subtitles and one-line paragraphs can be merged, for example. When no paragraph boundaries are present, then chunking can be done by dividing after ever N words (e.g., every 20 words), for example.

For clustering, one or more natural language processing (“NLP”) techniques can be applied to measure similarity between two collections of words, for example. For example, paragraphs including similar strings of words (e.g., N-grams) are identified, and a similarity metric is defined to determine whether two passages are similar. For example, a similarity metric can provide an output resembling a cosine function (e.g., results closer to a value of one indicate greater similarity). Passage similarity scores can be computed for all pairs of passages using these metrics.

In certain embodiments, it is computationally expensive to look at all combinations of clusters when there are many passages. Therefore, clustering can be performed in two steps: seed clustering and classification. In seed clustering, a complete-link algorithm can be used until a target number of clusters are found. For example, a target number of clusters can be equal to log(number of documents). In classification, remaining passages are then classified by finding a best matching seed cluster. If a passage has no similarity, it is placed in a trash cluster.

For summary generation, a most characteristic paragraph is then taken from each cluster to form a “meta document.” A single document summarizer is then used to create a “summary” for the entire collection. The summary is bundled with the information and provided as the bundle 140.

As an example of the workflow 100 in action, suppose that, prior to performing surgery on a patient, a physician wants to know what allergies a patient has. Information about a patient's allergies may be stored in different systems using a combination of document repositories, file systems, and databases 120. Using the ICE 125, a variety of information about the patent's allergies is found and bundled and presented to the physician. Some of the information may be buried within paragraphs in some documents, while other information is found in database tables, for example. When a system's databases have been exposed (e.g., through a Connectivity Framework), the ICE 125 and its QUEEN engine can connect to the database 120 to query for information. When a database is not available for a particular system, the document repository for that system can still be searched. The document summarizer 135 can be used to provide summaries of documents retrieved and to cluster related passages from documents retrieved to pull in related patient information. The information is organized into a bundle 140 before being delivered to the user. The information may be organized based on information type, semantics, information relevance, and the confidence score from the underlying repository, for example.

In certain embodiments, the workflow 100 supports a user by continually searching for relevant information from connectivity framework components using a query generation engine 115. Subsequently, these results are classified and bundled through an information composition engine 125 that transforms the information for appropriate presentation to the user.

In certain embodiment, an adaptive user interface (“UI”) design is achieved by taking advantage of semantic web technology. For example, domain concepts and relationships are characterized in a hierarchy of ontologies, associated with upper level ontological constructs that enable adaptive reasoning and extensibility.

A core ontology can be derived from one or more work-centered design principles. For example, an effective interface can display information that represents a perspective that a user needs on a situated work domain to solve particular types of problems. As another example, information that is the most important to the user in the current work context can be displayed in a focal area to engage the user's attention. Referential information can be offered in a periphery of a display to preserve context and support work management. As a further example, a user's own work ontology (e.g., terms and meaning) should be the primary source for information elements in the interface display.

Thus, certain embodiments provide adaptive user interface capabilities through use of a controller that can “reason” about metadata in an ontology to present users with a work-centered application tailored to individual needs and responsive to changes in the work domain. Such user interface capabilities help obviate problems associated with browsing “external” data that a connectivity framework can access by offering an interface to deliver targeted information in an application context-sensitive manner.

In human-computer interaction, user interface data, events, and frequencies can be displayed, recorded, and organized into episodes. By computing data positioned on a display screen, episode frequencies, and implication relations, application-specific episode associations can be automatically derived to enable an application interface to adaptively provide just-in-time assistance to a user. By identifying issues related to designing an adaptive user interface, including interaction tracking, episodes identification, user pattern recognition, user intention prediction, and user profile update, for example, the interface can act on a user's behalf to interact with an application based on certain recognized plans. To adapt to different users' needs, the interface can personalize its assistance by learning user profiles and disease-specific workflows, for example.

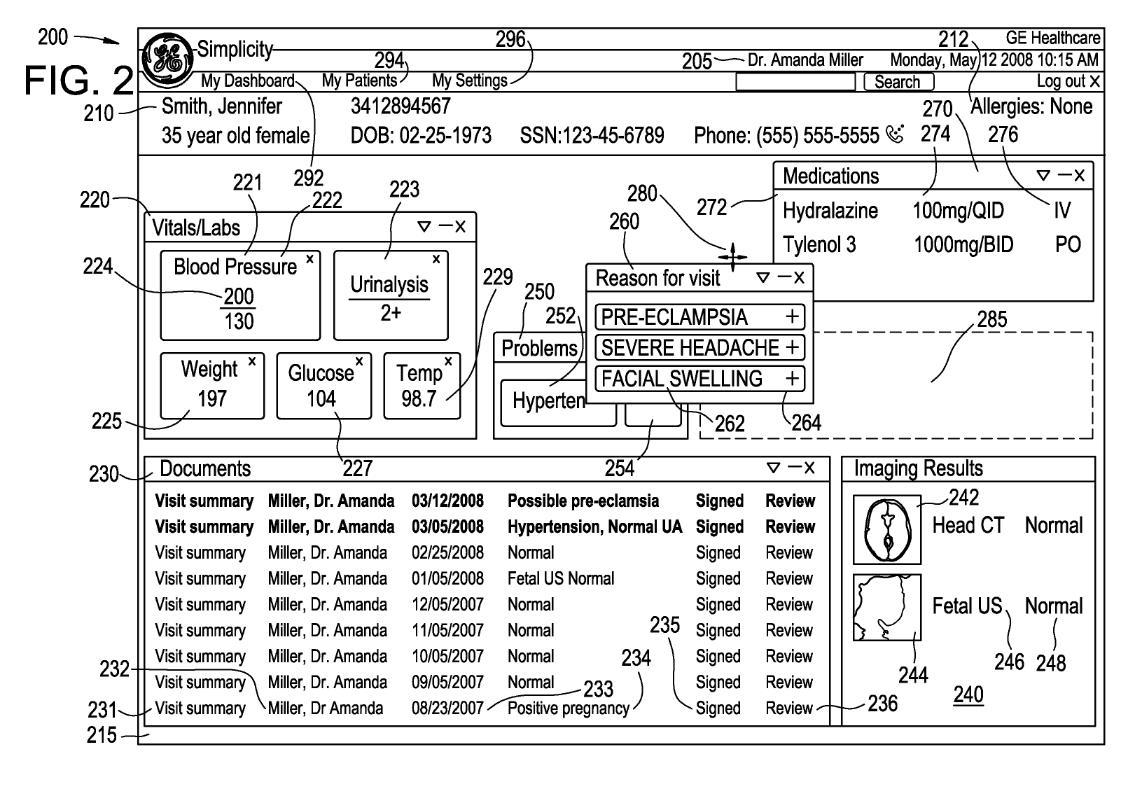

FIG. 2 shows an example adaptive user interface (“UI”) 200 in accordance with an embodiment of the present invention. The UI 200 includes a login and user identification area 205, a patient identification area 210, an alert 212, and a widget display area 215. The user identification area 205 identifies the user currently logged in for access to the UI 200. The patient identification area 210 provides identification information for a target patient, such as name, identification number, age, gender, date of birth, social security number, contact information, etc. The alert 212 can provide patient information for the attention of the user, such as an indication that the patient has no allergies. The widget display area 212 includes one or more widgets positionable by a user for use via the UI 200.

For example, as shown in FIG. 2, the widget display area 212 includes widgets 220, 230, 240, 250, 260, 280. Widgets can provide a variety of information, clinical decision support, search capability, clinical functionality, etc. As shown, for example, in FIG. 2, the widget 220 is a vitals/labs widget. The vitals widget 220 provides a visual indicator of one or more vital signs and/or lab test results for the patient. For example, indicators can include blood pressure 221, urinalysis 223, weight 225, glucose 227, and temperature 229. Each indicator includes a type and a value. For example, the blood pressure indicator 221 includes a type 222 (e.g., blood pressure) and a value 224 (e.g., 200 over 130). Each indicator 221, 223, 225, 227, 229 has a certain color and/or a certain size to indicate an importance of the constituent information from the indicator. For example, the blood pressure indicator 221 is the largest sized indicator in the widget 220, visually indicating to a user the relative importance of the blood pressure reading 221 over the other results. Urinalysis 223 would follow as next in importance, etc. As another example, blood pressure 221 is colored red, urinalysis 223 is colored orange, weight 225 is colored yellow, and both glucose 227 and temperature 229 are colored green. The color can be used to indicate a degree of severity or importance of the constituent value. For example, blood pressure 221, colored red, would carry the most importance, urinalysis 223, colored orange, would be next in importance, etc. Thus, indicator size and/or color can be used together and/or separately to provide the user with an immediate visual indication of a priority to be placed on investigation of patient vitals and lab results. In certain embodiments, selection of an indicator retrieves data, results, and/or document(s) used to generate the information for the indicator.

Widget 230 provides a list of clinical documents related to the patient, such as encounter summaries, reports, image analysis, etc. Document information can include a document type 231, a document author 232, a document date 233, an evaluation from the document 234, a document status 235, and an action for the document 236. For example, an entry in the document widget 230 can be of visit summary type 231, generated by author 232 Dr. Amanda Miller, on a date 233 of Mar. 12, 2008, diagnosing 234 possible pre-eclampsia, with a status 235 of signed, and an action 236 of review. A user can select a document entry to retrieve and display the actual document referenced in the widget 230.

Widget 240 provides one or more imaging studies for review by the user. The imaging studies widget 240 includes one or more images 244 along with an imaging type 246 and an evaluation 248. For example, as shown in FIG. 2, the widget 240 includes a head CT evaluated as normal and a fetal ultrasound image evaluated as normal.

Widget 250 provides a visual representation of one or more problems 252, 254 identified for the patient. Similar to the vitals widget 220, the problem indicators 252, 254 can have a certain color and/or a certain size to indicate an importance of the constituent information from the problem indicator. For example, in the hypertension problem indicator 242 is colored red and is larger than the other problem indicator 254. Thus, indicator size and/or color can be used together and/or separately to provide the user with an immediate visual indication of a priority to be placed on investigation of patient problems. In certain embodiments, selection of a problem indicator retrieves data, results, and/or document(s) used to generate the information for the indicator.

Widget 260 provides one or more reasons for a patient's visit to the user. The reason for visit widget 260 includes a reason 262 and an icon 264 allowing the user to expand the reason 262 to view additional detail or collapse the reason 262 to hide additional detail. The reasons 262 can be color coded like the indicators from widgets 220, 250 to provide a visual indication of priority, significance, severity, etc.

Widget 270 provides a listing of medications prescribed to the patient. The medications widget 270 includes a type 272 of medication, a quantity 274 of the medication, and a delivery mechanism 276 for the medication. In certain embodiments, selection of a medication can pull up further detail about the medication and its associated order, for example.

As shown, for example, in FIG. 2, a user can manipulate a cursor 280 to select a widget and position the widget at a location 285. Thus, a user can select widgets for display and then arrange their layout in the widget display area 215 of the UI 200. Alternatively and/or in addition, the user can reposition widgets in the widget display area 215 to modify the UI 200 layout. For example, using the cursor 280, the user can place the reason for visit widget 260 in a certain spot 285 on the widget display area 215.

The UI 200 can also provide one or more links to other clinical functionality, such as a user dashboard 292, a patient list 294, a settings/preferences panel 296, and the like.

Certain embodiments allow healthcare information systems to find and make use of relevant information across a timeline of patient care. For example, a search-driven, role-based interface allows an end user to access, input, and search medical information seamlessly across a healthcare network. An adaptive user interface provides capabilities through a work-centered interface tailored to individual needs and responsive to changes in a work domain, for example. Semantic technology can be leveraged to model domain concepts, user roles and tasks, and information relationships. The semantic models enable applications to find, organize and present information to users more effectively based on contextual information about the user and task. Components forming a framework for query and result generation include user interface frameworks/components for building applications; server components to enable more efficient retrieval, aggregation, and composition of information based on semantic information and context; and data access mechanisms for connecting to heterogeneous information sources in a distributed environment.

A variety of user interface frameworks and technologies can be used to build applications including, Microsoft® ASP.NET, Ajax®, Microsoft® Windows Presentation Foundation, Google® Web Toolkit, Microsoft® Silverlight, Adobe®, and others. Applications can be composed from libraries of information widgets to display multi-content and multi-media information, for example. In addition, the framework enables users to tailor layout of the widgets and interact with underlying data.

Healthcare information can be distributed among multiple applications using a variety of database and storage technologies and data formats. To provide a common interface and access to data residing across these applications, a connectivity framework (“CF”) is provided which leverages common data and service models (“CDM” and “CSM”) and service oriented technologies, such as an enterprise service bus (“ESB”) to provide access to the data.

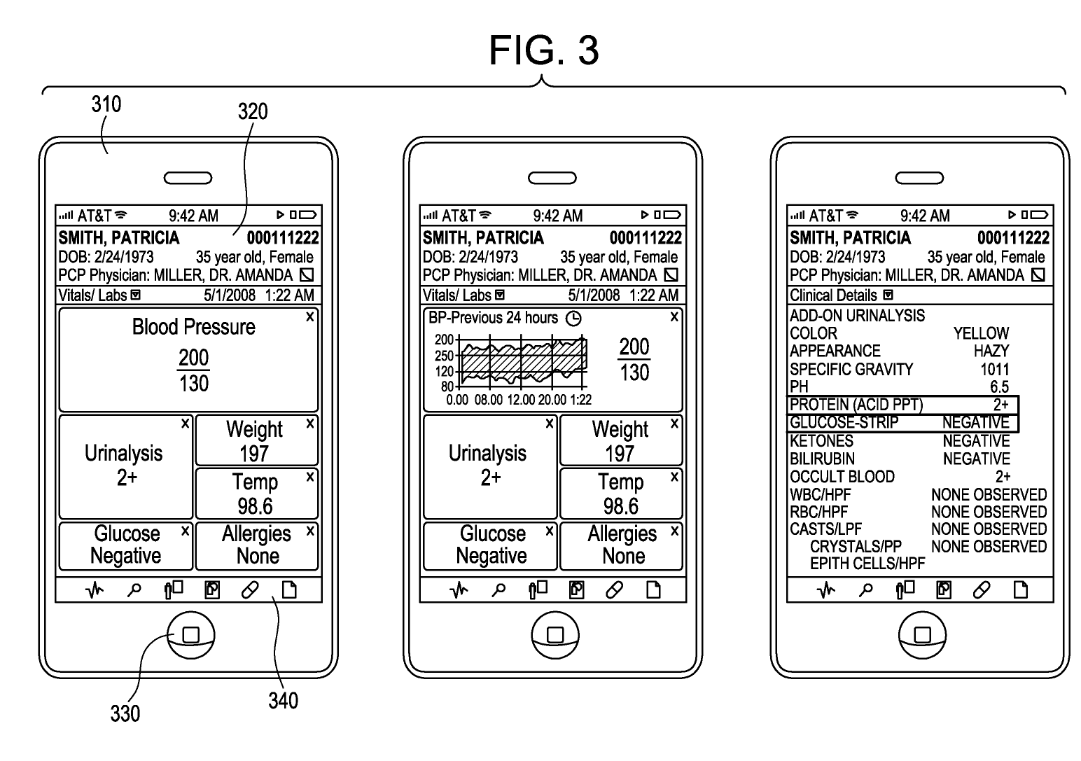

FIG. 3 depicts example mobile devices including a user interface, such as the user interface described in relation to FIG. 2. As shown in FIG. 3, a mobile device 310 can include a graphical user interface 320, a navigation device 330, and one or more tools 340 for interaction with the content of the interface 320, for example. The mobile device 310 can include a cellular phone, personal digital assistant, pocket personal computer, and/or other portable computing device. The mobile device 310 includes a communication interface to exchange data with an external system, for example.

A combination of mobile services and Web services can be used for delivery of information via the mobile device 310. Using Mobile Web Technology, portability, ubiquitous connectivity, and location-based services can be added to enhance information and services found on the Web. Applications and various media do not need to reside in separate silos. Instead, applications on these devices 310 can bring together elements of Web 2.0 applications, traditional desktop applications, multimedia video and audio, and the mobile device (e.g., a cell phone), for example. Using an adaptive user interface architecture, widgets can be designed for mobile devices to enable users to create or consume important clinical information whenever and wherever they need it, for example.

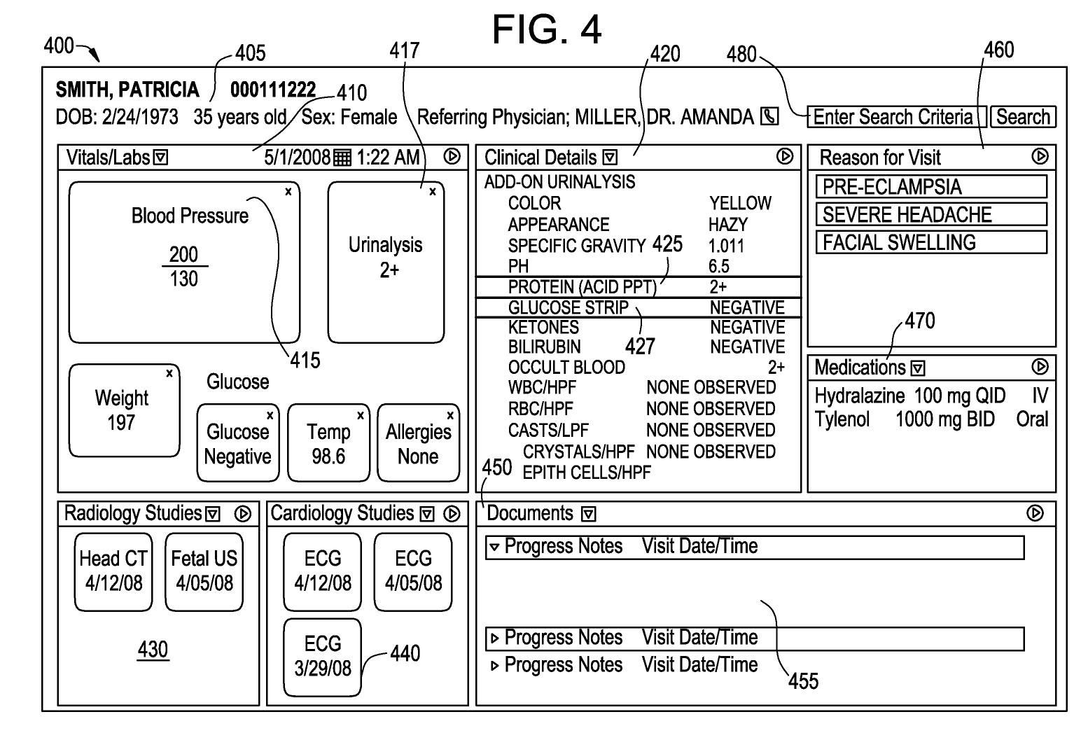

FIG. 4 illustrates an example use case of an adaptive, work-centered user interface 400 in perinatal care in accordance with an embodiment of the present invention. In the example of FIG. 4, Patricia Smith, a 35-year old pregnant female, is in her 34th week of her third pregnancy. Throughout the course of her care, Patricia has had the typical workup, including initial lab studies, vitals, a three-dimensional (“3D”) fetal ultrasound, and other routine tests. With the exception of her gestational diabetes, Patricia has had a normal pregnancy, and all indications are that she'll deliver a healthy baby boy at full term.

At her 34-week appointment, however, Patricia's obstetrician/gynecologist becomes somewhat concerned at her blood pressure, which is high compared to previous readings, at 145/95. Dr. Amanda Miller orders an electrocardiogram (“EKG”) and a urinalysis (“UA”) test. Although Patricia's EKG shows a normal sinus rhythm, her UA comes back with trace amounts of Albumin, suggestive of pre-eclampsia. Dr. Miller asks Patricia to set up her next appointment for one week from today to monitor her blood pressure and kidney function.

The following week, Patricia's blood pressure is higher than the previous value (150/98) and Dr. Miller orders another urinalysis. The UA comes back positive again, but at about the same level as before. Dr. Miller feels it's prudent to continue the weekly visits until her blood pressure comes down to normal levels. She also mentions to Patricia that one warning sign of eclampsia is a sudden, severe headache, and, if she experiences one, she should go directly to the Emergency Department for care.

At her son's fifth birthday party over the weekend, Patricia comes down with a severe headache. Tom, her husband, immediately takes her to the Emergency Department (“ED”) at the local hospital. The ED staff access all of Patricia's medical records via a longitudinal timeline record, for example, and become informed about all of the aspects of her case. With Patricia's blood pressure (“BP”) skyrocketing at 200/130, the ED doc orders a series of tests—UA, EKG, Chem Panel, and a Head CT. Both the Chem Panel and Head CT come back normal but, just as Dr. Miller feared, the UA shows and elevated level of Albumin (2+). Given the result of the tests and Patricia's condition, the ED doc and Dr. Miller decide the best course of action is to deliver the baby via a C-section as soon as Patricia's blood pressure comes under control. She is administered Hydralazine (through her IV) to control the hypertension and Tylenol 3 for her headache, and is transported to surgical holding.

The C-section was a success, and Patricia and Tom are the proud parents of Evan, a six-pound, four-ounce healthy baby boy. After a week's stay, both Patricia and Evan are discharged from the hospital. Both Patricia and Evan are examined a week later at Dr. Miller's office. Patricia's albumin and blood pressure have returned to normal, as has her blood glucose level.

Using the user interface 400, Dr. Miller can easily review, enter, and modify Patricia's progress, lab results, vitals, etc., based on an identification of the patient 405. The UI 400 shows Patricia's vitals 410 and visually indicates through a large, red icon 415 that Patricia's blood pressure is of concern. Additionally, abnormal urinalysis results 417 are visually highlighted to the physician. Clinical details 410 of the urinalysis can be easily reviewed, with key results highlighted to indicate positive 425 or negative 427 results. Dr. Miller can review the radiology 430 and cardiology 440 studies she ordered for Patricia and can check documents 450, including previous progress notes 455 to evaluate Patricia's progress. Dr. Miller (and/or an assisting nurse, for example) can also enter and review Patricia's reasons for visiting the hospital 460. After prescribing the Hydralazine and Tylenol 3, Dr. Miller can verify the dosage and delivery methods and modify them following the C-section via a Medications widget 470. If Dr. Miller has further questions and/or wants to search for additional information, a search field 480 allows her to do so.

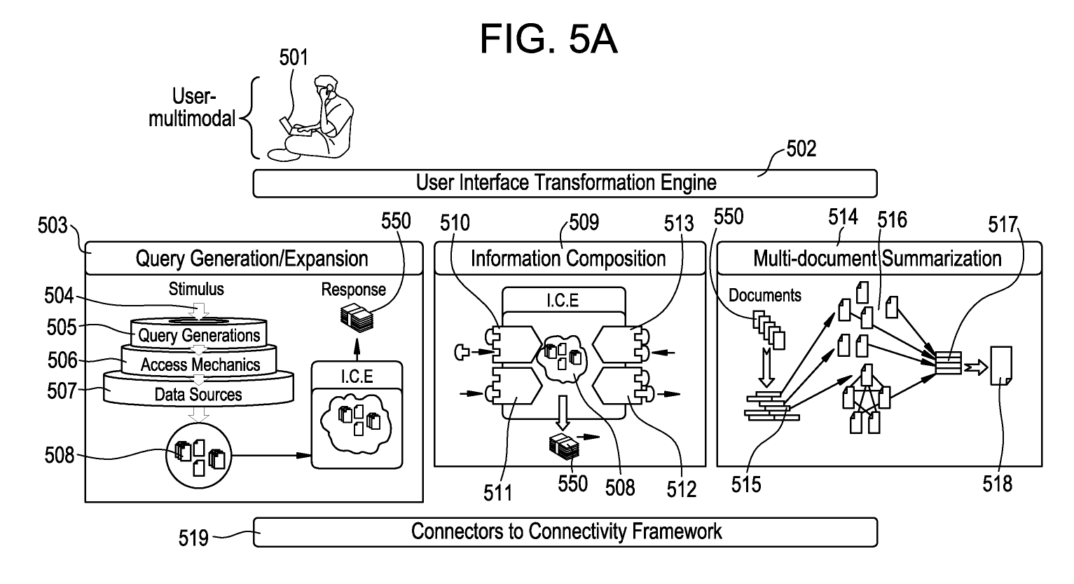

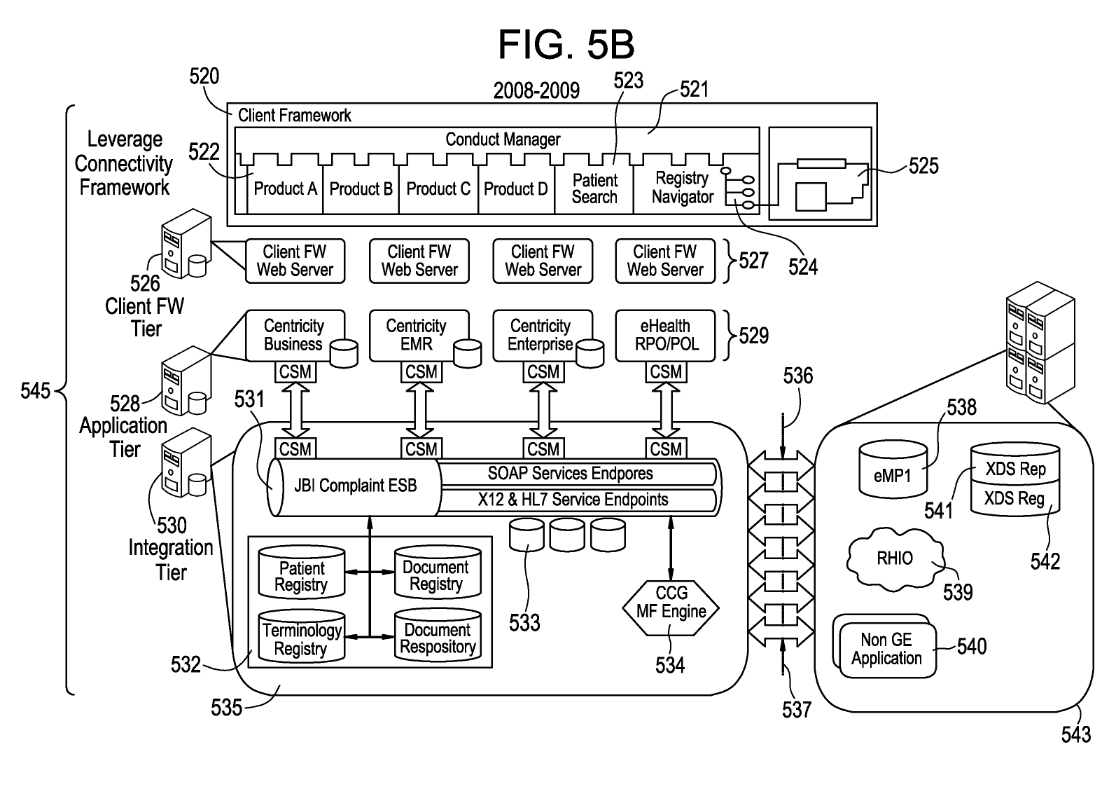

FIG. 5 depicts a user interface architecture 500 in accordance with certain embodiments of the present invention. The architecture 500 includes a user interface transformation engine 502, a query generation/expansion engine 503, an information composition engine 509, a multi-document summarization engine 514, and one or more connectors 519 to a connectivity framework 545. The components of the architecture 500 are accessible by a user via a user interface 501 on a processing device, such as a computer or handheld device. The user can submit a query for information via the user interface 501, for example.

The query generation/expansion engine 503 includes a stimulus 504, one or more query generators 505, and one or more access mechanisms 506 to search one or more data source 507 to produce a query and collected documents 508. The query and collected documents 508 are passed to the information composition engine 509 that includes applications 510, 511, 512, 513 that process and apply cognitive reasoning, for example, to organize the query and collected documents 508 into one or more units meaningful to a requesting user based on one or more of semantic guidelines, user preferences, and domain-related information, for example. A toolset including composers can employ Composition Decision Logic (“CDL”), such as aggregation, elimination of redundant information, lightweight summarization of information, and fusion of results, to compose the information. Applications can include one or more data driven applications 510, enterprise application interfaces 511, task/process driven applications 512, and data structure specific applications 513, for example. The applications 510, 511, 512, and/or 513 can include one or more templates related to new data types, new data structures, domain specific tasks/processes, new application interfaces, etc. Composition and processing of the query and collected documents 508 produces a bundle 550 of information in response to a user query.

The multi-document summarization engine 514 receives the bundle 550 of documents and segments the documents into passages 515. The passages 515 are clustered based on similar concepts 516. A meta-document 517 is then formed from the concepts 516. A summary 518 is generated from the meta-document 517. Query results 550, the meta-document 517, and/or the meta-document summary 518 can be provided to the user via the user interface 501.

Via connectors 519 to a connectivity framework 545, the user interface 501 and its engines 503, 509, 514 can send and receive information in response to user query via the interface 501, for example. For example, the query engine 503 can access the connectivity framework 545 to query one or more data sources 507.

The connectivity framework 545 includes a client framework 520. The client framework 520 includes a context manager 521 for one or more products 522, a patient search 523, a registry navigator 524, and a viewer 525. Thus, in certain embodiments, the connectivity framework 520 can facilitate viewing and access to information via the user interface 501 and apart from the user interface 501. Via the connectivity framework 545, the query engine 503 and/or other parts of the user interface 501 can access information and/or services through a plurality of tiers.

Tiers can include a client framework tier 526, an application tier 528, and an integration tier 530, for example. The client framework tier 526 includes one or more client web servers 527 facilitating input and output of information, for example. The applicant tier 528 includes one or more applications 529 related to enterprise and/or departmental usage such as business applications, electronic medical records, enterprise applications, electronic health portal, etc. The integration tier 530 includes a consolidated interoperability platform server 535 in communication with customer information technology (“IT”) 543 via one or more factory 536 and/or custom 537 interfaces, such as default and/or customized interfaces using a variety of message formats such as a web service (“WS”), X12, Health Level Seven (“HL7”), etc. The consolidated interoperability platform 535 can communicate with the one or more applications 529 in the application tier 528 via a common service model (“CSM”), for example.

As shown, for example, in FIG. 5, the consolidated interoperability platform 535 includes an enterprise service bus (“ESB”) 531, a collection of registries, data, and services 532, configuration information 533, and a clinical content gateway (“CCG”) interface engine 534, for example. The ESB 531 can be a Java business intelligence (“JBI”) compliant ESB, for example. The ESB 531 can include one or more endpoints or locations for accessing a Web service using a particular protocol/data format, such as X12, HL7, SOAP (simple object access protocol), etc., to transmit messages and/or other data, for example. Using a CSM, the ESB 531 facilitates communication with the applications 529 in the application tier 528, for example. Via the ESB 531, information in the registries, data and services repository 532 can be provided to the applicant tier 531 in response to a query, for example. Configuration information 533 can be used to specify one or more parameters such as authorized users, levels of authorization for individual users and/or groups/types of users, security configuration information, privacy settings, audit information, etc. The CCG interface engine 531 receives data from the customer IT framework 543 and provides the data to the registries 532 and/or applications 529 in the application tier 531, for example.

As shown, for example, in FIG. 5, the customer IT 543 includes support for a third party electronic message passing interface (“eMPI”) 538, support for a regional health information organization (“RHIO”) 539, one or more third party applications 540, support for a cross-enterprise document sharing (“XDS”) repository 541, support for an XDS registry 542, and the like. Using customer IT 543 in conjunction with the interoperability platform 535, a RHIO gateway and third party application integration can be provided via one or more interfaces to the connectivity framework 545 and/or the query generation/expansion engine 503 of the user interface 501.

The customer IT framework 543 can be organized to provide storage, access and searchability of healthcare information across a plurality of organizations. The customer IT framework 543 may service a community, a region, a nation, a group of related healthcare institutions, etc. For example, the customer IT framework 543 can be implemented with the RHIO 539, a national health information network (“NHIN”), a medical quality improvement consortium (“MQIC”), etc. In certain embodiments, the customer IT 543 connects healthcare information systems and helps make them interoperable in a secure, sustainable, and standards-based manner.

In certain embodiments, the customer IT framework 543 provides a technical architecture, web applications, a data repository including EMR capability and a population-based clinical quality reporting system, for example. The architecture includes components for document storage, querying, and connectivity, such as the XDS registry 542 and repository 541. In certain embodiments, the XDS registry 542 and repository 541 can include an option for a subscription-based EMR for physicians, for example. In certain embodiments, the XDS registry 542 and repository 541 are implemented as a database or other data store adapted to store patient medical record data and associated audit logs in encrypted form, accessible to a patient as well as authorized medical clinics. In an embodiment, the XDS registry 542 and repository 541 can be implemented as a server or a group of servers. The XDS registry 542 and repository 541 can also be one server or group of servers that is connected to other servers or groups of servers at separate physical locations. The XDS registry 542 and repository 541 can represent single units, separate units, or groups of units in separate forms and may be implemented in hardware and/or in software. The XDS registry 542 and repository 541 can receive medical information from a plurality of sources.

Using an XDS standard, for example, in the customer IT framework 543, document querying and storage can be integrated for more efficient and uniform information exchange. Using the customer IT 543, quality reporting and research may be integrated in and/or with an RHIO 539 and/or other environment. The customer IT 543 can provide a single-vendor integrated system that can integrate and adapt to other standards-based systems, for example.

Via the customer IT framework 543, a group of EMR users may agree to pool data at the XDS registry 542 and repository 541. The customer IT framework 543 can then provide the group with access to aggregated data for research, best practices for patient diagnosis and treatment, quality improvement tools, etc.

XDS provides registration, distribution, and access across healthcare enterprises to clinical documents forming a patient EMR. XDS provides support for storage, indexing, and query/retrieval of patient documents via a scalable architecture. Certain embodiments, however, support multiple affinity domains (defined as a group of healthcare enterprise systems that have agreed upon policies to share their medical content with each other via a common set of policies and a single registry) such that each affinity domain retains its autonomy as a separate affinity domain but shares one instance of hardware and software with the other involved affinity domains. The XDS registry and repository 541 can maintain an affinity domain relationship table used to describe clinical systems participating in each affinity domain. Once a request for a document is made, the source of the request is known and is used to determine which document(s) in the repository 541 are exposed to the requesting user, thus maintaining the autonomy of the affinity domain.

In certain embodiments, the XDS registry 542 and repository 541 represent a central database for storing encrypted update-transactions for patient medical records, including usage history. In an embodiment, the XDS registry 542 and repository 541 also store patient medical records. The XDS registry 542 and repository 541 store and control access to encrypted information. In an embodiment, medical records can be stored without using logic structures specific to medical records. In such a manner the XDS registry 542 and repository 541 is not searchable. For example, a patient's data can be encrypted with a unique patient-owned key at the source of the data. The data is then uploaded to the XDS registry 542 and repository 541. The patient's data can be downloaded to, for example, a computer unit and decrypted locally with the encryption key. In an embodiment, accessing software, for example software used by the patient and software used by the medical clinic performs the encryption/decryption.

In certain embodiments, the XDS registry 542 and repository 541 maintain a registration of patients and a registration of medical clinics. Medical clinics may be registered in the XDS registry 542 and repository 541 with name, address, and other identifying information. The medical clinics are issued an electronic key that is associated with a certificate. The medical clinics are also granted a security category. The security category is typically based on clinic type. In certain embodiments, the requests and data sent from medical clinics are digitally signed with the clinic's certificate and authenticated by the XDS registry 542 and repository 541. Patients may be registered in the XDS registry 542 and repository 541 with a patient identifier and password hash. Patients may also be registered in the XDS registry 542 and repository 541 with name, address, and other identifying information. Typically, registered patients are issued a token containing a unique patient identifier and encryption key. The token may be, for example, a magnetic card, a fob card, or some other equipment that may be used to identify the patient. A patient may access the XDS registry 542 and repository 541 utilizing their token, and, in an embodiment, a user identifier and password.

In certain embodiments, design of the user interface architecture 500 is guided by a plurality of factors related to the interactive nature of the system. For example, one factor is visibility of system status. The system can keep users informed about what is going on through appropriate feedback within reasonable time. Additionally, another factor is a match between the system and the “real world.” The system can speak the user's language, with words, phrases and concepts familiar to the user, rather than system-oriented terms. For example, information can follow real-world conventions and appear in a natural and logical order. Additionally, with respect to consistency and standards, users should not have to wonder whether different words, situations, or actions mean the same thing. The interface architecture can follow platform conventions, for example.

Another example factor relates to user control and freedom. Users often choose system functions by mistake and need a clearly marked “emergency exit” to leave the unwanted state without having to go through an extended dialogue. Certain embodiments support undo and redo operations related to configuration of system parameters and information query, for example.

Another factor is error prevention. Error-prone conditions can be eliminated, or the system can check for error conditions and present users with a confirmation option before a remedial action is executed. Additionally, certain embodiments can help users recognize, diagnose, and recover from errors. Error messages can be expressed in plain language (e.g., no codes), precisely indicate the problem, and constructively suggest a solution, for example. Even though it is better if the system can be used without documentation, it may be necessary to provide help and documentation. Any such information can be easy to search, focused on the user's task, list concrete steps to be carried out, and not be too large, for example.

With respect to ease of user interaction, the system can reduce or minimize the user's memory load by making objects, actions, and options visible. The user should not have to remember information from one part of the dialogue to another. Instructions for use of the system can be visible or easily retrievable whenever appropriate. Further, accelerators, often unseen by a novice user, can often speed up interaction for an expert user such that the system can cater to both inexperienced and experienced users. In certain embodiments, users can tailor frequent actions. Additionally, displayed dialogues can be configured not to include information that is irrelevant or rarely needed. Every extra unit of information in a dialogue competes with the relevant units of information and diminishes their relative visibility.

Certain embodiments provide visualization strategies with a graphical user interface for disparate data types across large clinical datasets across an enterprise. Thus, design elements can include, for example, institutional components, a single point of access search, one or more components/widgets, one or more medical records grids/forms, scheduling, clinical data results, graphs, task lists, messaging/collaboration components, multi-scale images (e.g., deep zoom), one or more external components, mail, RSS feeds, external Web-based clinical tools (e.g., WebMD), etc. Server components can include, for example, a search engine, a Web server, an active listener, an information composition engine, a query engine, a data aggregator, a document summarizer, profile context management, one or more dashboards (e.g., clinical and administrative), etc.

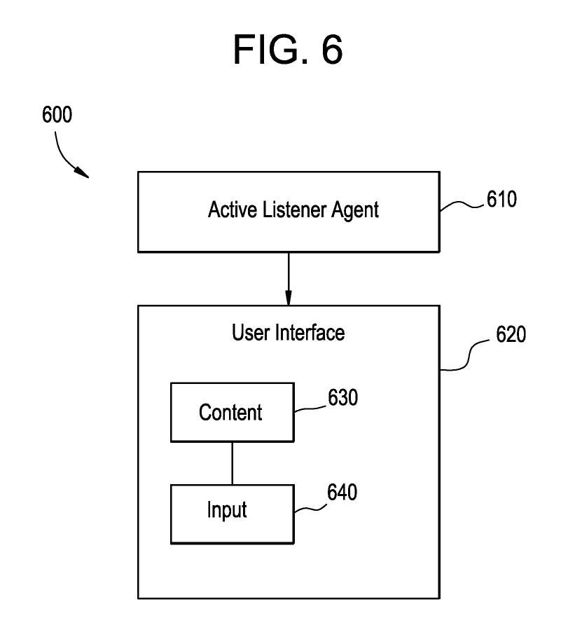

FIG. 6 depicts an example adaptive user interface system 600 including active listening and response capability in accordance with an embodiment of the present invention. The system 600 includes an active listener agent 610, a user interface 620, content 630, and input 640, for example. Components of the system 600 can be implemented in software, hardware, and/or firmware in various separate and/or integrated combinations, for example.

Content 630 is displayed to a user via the user interface 620. Content 630 can include one or more widgets, such as widgets described above in relation to FIGS. 2 and 4, applications, data displays, images, etc. Via the user interface 620, a user can provide input 640 to affect content 630 displayed on the interface 620. The active listener agent 610 monitors displayed content 630 and user input 640 in the background of the user interface 620. In response to user input 640 based on content 630, the active listener agent 610 can provide further content 630 related to existing content 630 and input 640 via the user interface 620. The active listener agent 610 can find, organize, and present information to users based on contextual information about the user and the user's task, for example.

For example, as shown in FIG. 2, the user interface 200 displays content 630 such as a vitals widget 220 and a patient problems widget 250. When a user inputs 640 a patient's reason for visit 250, the active listener agent 610 determines that the patient's current medication would be of interest to the physician reviewing her problems and reason for visit and provides additional content 630 in the form of the medication information widget 270.

As another example, turning to FIG. 4, the user interface 400 displays content 630 such as a vitals/labs widget 410, a medications widget 470, an a reason for visit widget 460, among others. The active listener agent 610 can monitor the content 630 and user input 640. Based on the urinalysis information 417 from the vitals/labs widget 410, the active listener agent 610 determines that the user may likely be interested in further clinical detail 420 regarding the urinalysis and related lab results. Thus, the clinical lab detail panel 420 can be provided via the interface 400, for example.

In certain embodiments, in addition to displaying additional 630 that are retrieved from a library of widget/application and patient information, for example, the active listener agent 610 can generate new content 630 based on existing content 630 and/or input 640. For example, if a user drags patient medication information from a medication widget or application (such as the medications widget 270 shown in FIG. 2) and brings it into a patient problems widget or application (such as the problems widget 250 shown in FIG. 2), a new widget can be generated (and/or the problems widget can be modified) to show a correlation between a patient problem, such as hypertension and a medication being taken by the patient, such as hydralazine, to combat the problem.

In certain embodiments, a modified and/or newly created widget and/or other application can be saved for later use. For example, a user can save the widget, and/or the system can automatically save the widget. For example, the widget can be generally saved and/or saved in connection with a particular user, mode, group, etc.

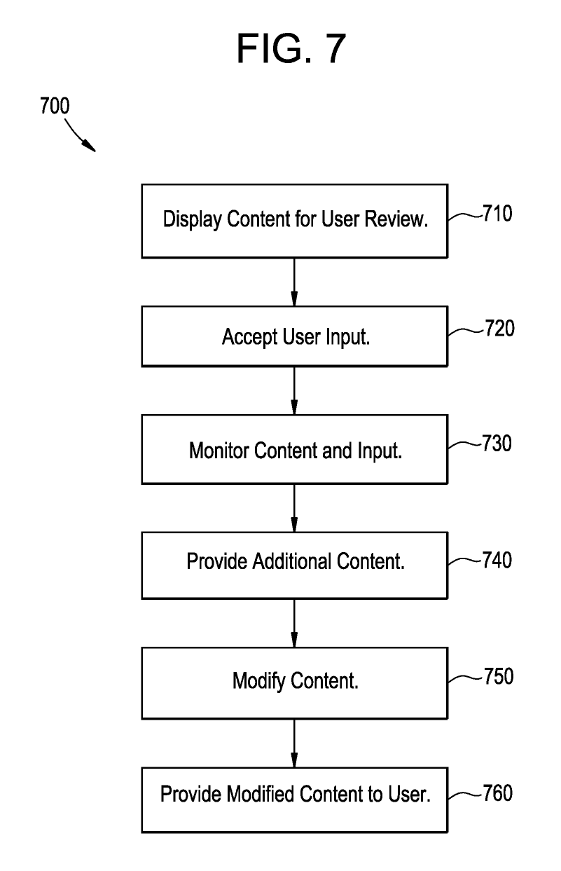

FIG. 7 shows a flow diagram for a method 700 for adaptive user interfacing with clinical content in accordance with certain embodiments of the present invention.

At 710, content is displayed for user review. For example, clinical content related to a patient can be displayed to a user via a user interface in response to a user request, such as access to a patient's electronic medical record information.

At 720, user input is accepted. For example, via the user interface, the user can modify displayed information, interact with a displayed application, add information, request further information, etc. For example, user input can include a request for information about a patient, activation of a widget, positioning of information in a user interface display, etc. User input can include information regarding a patient encounter such as a stimulus and a context. User input can be provided directly by a user and/or extracted via another application or widget displayed for the user via the interface, for example.

At 730, content and input are monitored. For example, an active listener can “listen” or monitor content and activity via the user interface to identify patterns of use, subject matter of interest, changes to displayed applications and/or content, etc.

At 740, additional content is provided. For example, based on displayed content and user interaction with that content, the active listener provides additional content that may be of use to the user.

At 750, content is modified. For example, based on user interaction with displayed content (e.g., applications and data), the content can be modified. For example, patient data can be updated by a user via the interface. As another example, a user can input and/or transfer information from one application to another application to create a new application (e.g., a new user interface widget) and/or modify an existing application.

At 760, modified content is provided to the user. For example, the updated patient data, new application, modified application, etc., are provided to the user via the user interface. For example, thumbnails, links, summaries, and/or other representations of data can be graphically provided to the user via the user interface. Selection of a thumbnail, link, summary, etc., may generate a further level of detail for review by the user and/or retrieval and display of source documents, for example. Additionally, a new widget can be selected and displayed from a library based on monitored content and/or action. Alternatively or in addition, a new widget can be created from existing widget and/or other information for use by the user via the interface. Modified information can be saved for later use, for example.

One or more of the steps of the method 700 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these steps and/or perform the steps in a different order than the order listed. For example, some steps may not be performed in certain examples. As a further example, certain steps may be performed in a different temporal order, including simultaneously, than listed above.

Thus, certain embodiments provide a plurality of benefits including a single point of access, cross-modality data access, XDS compliance, push and pull capability, consensus building, transparency, knowledge management enhanced by use, cross platform (Web, mobile, etc.) accessibility, and a system level view of a user's information space, for example.

Certain embodiments provide an architecture and framework for a variety of clinical applications. The framework can include front-end components including but not limited to a Graphical User Interface (GUI) and can be a thin client and/or thick client system to varying degree, which some or all applications and processing running on a client workstation, on a server, and/or running partially on a client workstation and partially on a server, for example.

The example user interface systems and methods described herein can be used in conjunction with one or more clinical information systems, such as a hospital information system (“HIS”), a radiology information system (“RIS”), a picture archiving and communication system (“PACS”), a cardiovascular information system (“CVIS”), a library information system (“LIS”), an enterprise clinical information system (“ECIS”), an electronic medical record system (“EMR”), a laboratory results/order system, etc. Such systems can be implemented in software, hardware, and/or firmware, for example. In certain implementations, one or more of the systems can be implemented remotely via a thin client and/or downloadable software solution. Furthermore, one or more components can be combined and/or implemented together.

In certain embodiments, an active listener agent operates in a foreground and/or background of a computing device and/or software application, such as a user interface, to monitor user and program activity. For example, the active listener agent can gather information related to widgets in a user interface. The active listener agent can gather information related to actions generated by a user with respect to the user interface and its content, for example.

In certain embodiments, based on application (e.g., widget) information and user interaction, the active listener agent can identify information and/or functionality important to a user based on a current context. In an embodiment, if the active listener agent detects that one or more data elements displayed on a user interface reach a predetermined threshold, the active listener automatically places one or more widgets on the user interface that include additional relevant information to help enable the user to make a well-informed decision. In another embodiment, the active listener agent can help the user by reacting to the user's interaction with an application and provide additional insight by displaying additional information in the form of widget(s) and/or other information on a displayed user interface as a result of the user's actions. For example, if the user drags a certain data element from one widget to another widget (e.g., via cursor selection of the element and movement across a displayed interface using a mousing device), the active listener agent can reposition (e.g., size and/or location) that information on the displayed interface so that an arrangement of data elements signifies a different level of information useful in helping the user arrive at a conclusion (e.g., regarding diagnosis and/or treatment of a patient). The active listener agent can then either place a pre-made relevant widget on the interface that could be helpful a the particular scenario and/or can create a new widget based on the content of the widget the user changed in addition to the data context on the user interface.

Rather than focus on pre-determined workflows, the active listener provides a user with additional information helpful to the user in certain situations where there is no known workflow or protocol. Based on historical data and/or other input, the system displays additional information and/or functionality to the user that is relevant to the user to make an informed decision. In the background of an application and/or interface, for example, the active listener can monitor activity of data elements on a displayed interface. When these data elements reach a certain threshold, the active listener places additional information on the displayed interface to help the user make an informed decision. Alternatively or additionally, the active listener can detect when the user makes a change to an application (e.g., by dragging and dropping a data element from on widget to another widget, by conducting a search, by changing a diagnosis, etc.). By combining a context of user interaction with displayed user interface content, relevant information and/or functionality can be provided to a user, for example.

In certain embodiments, a data element communication (“DEC”) widget (e.g., a “velcro” widget) enables a user to select or pull any clinical element(s) from any other widget on the user interface screen and deposit the selected clinical element(s) into a “holding bin” or holding area in the DEC widget. A clinical element can represent patient information, other clinical detail, and/or a summarized representation of the detail data that is hidden behind the summary representation, for example. Selection and transmission of clinical element(s) and/or related information can be executed alone and/or in conjunction with an active listener agent, such as an active listener agent described above, for example. For example, in certain embodiments, the active listener agent can automatically populate the holding area 800 based on certain rules, criteria, observed usage patterns, etc.

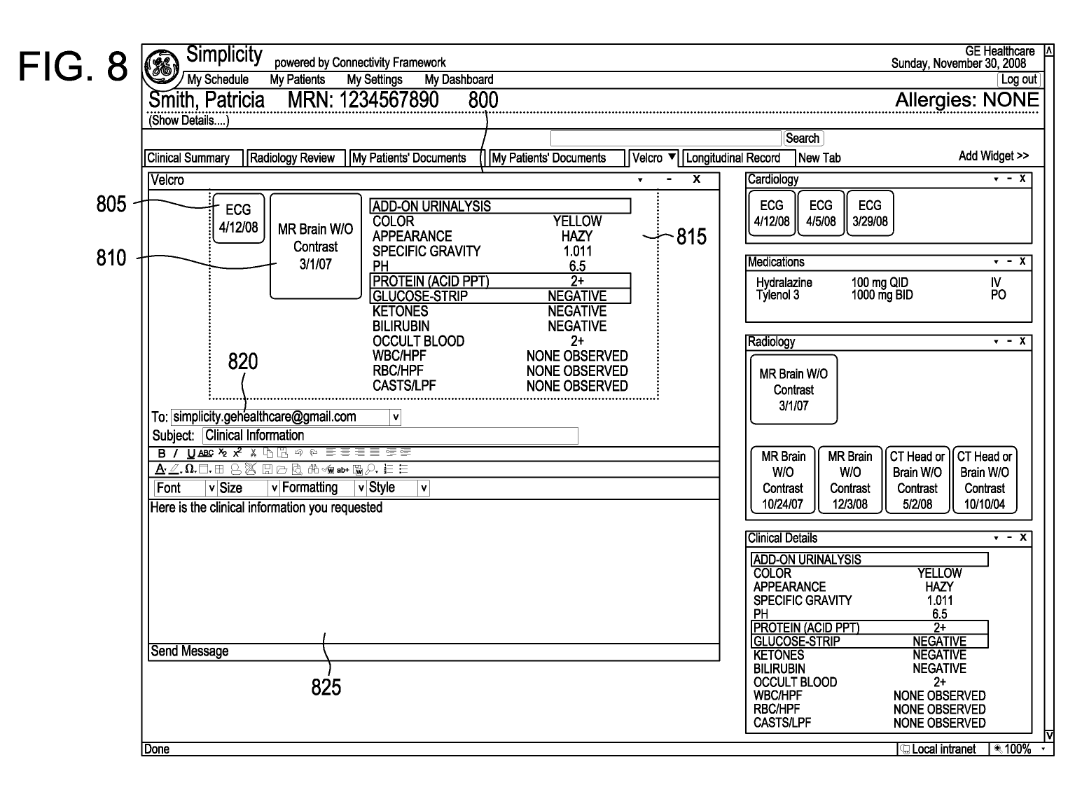

As shown, for example, in FIG. 8, a holding area 800 for a DEC widget includes an ECG representation 805, a brain MR image or image series 810, clinical details 815, etc. The representations 805, 810, 815, etc., provide a graphical reference and/or link to underlying clinical content, for example (such as in connection with one or more of the widgets described above in relation to FIGS. 1-7). The tool or widget operating in conjunction with the holding bin or area 800 allows a user to select an appropriate person or persons to email and/or otherwise transmit the information in the holding area 800. Target(s) 820 can be specified, and additional information or detail 825 can be provided to describe the data being sent. The user can select “send message” to transmit the message to the recipient(s). In certain embodiments, the holding area 800 can include or be included in the message area 825.

When a recipient receives the message, the email and/or other transmission can include the transmitting user selected information as well as, in certain embodiments, detail information embedded into the message that is represented by the widget objects 805, 810, 815, etc. The message can be received at a user's email in-box, added as a database record, generated as a user interface widget, etc. The message can also be routed to a healthcare information system, an electronic medical record, an electronic order system, an electronic processing system, a data store or archive, etc.

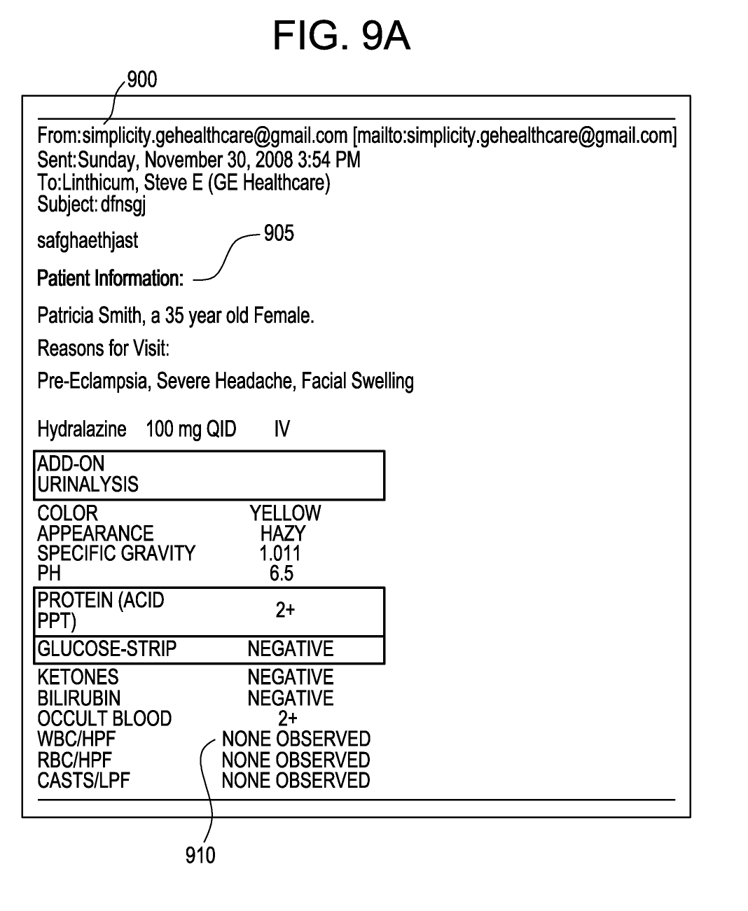

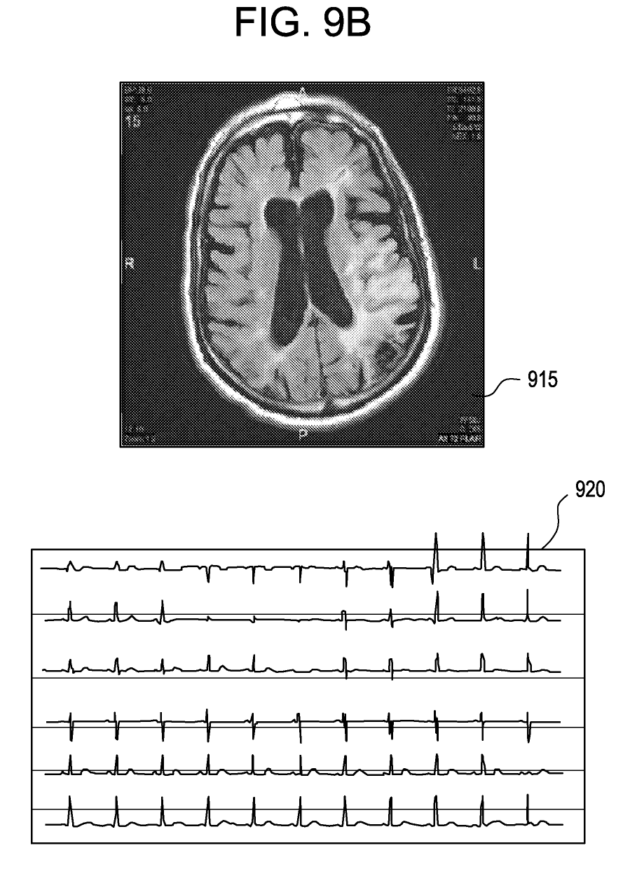

In certain embodiments, graphical representations (e.g., colored squares of varying sizes) are replaced with the detail data. For example, as shown in FIG. 9, an email 900 sent to a recipient includes expanded detail regarding the ECG representation 805, brain MR image 810, and clinical details 815 from the holding area 800 shown in FIG. 8. The email 900 includes patient information 905, clinical detail 910, an MR image 915, and patient ECG data 920.

In certain embodiments, information from the message 900 can be transferred to another application or interface, for example. For example, a recipient can extract content from the message 900 and transfer the content to a user interface widget, storage, other transmission, and/or other application for processing. As another example, the message 900 can be received by a widget or application that displays the content for the recipient and/or processes/distributes the content of the message 900 to one or more applications and/or storage.

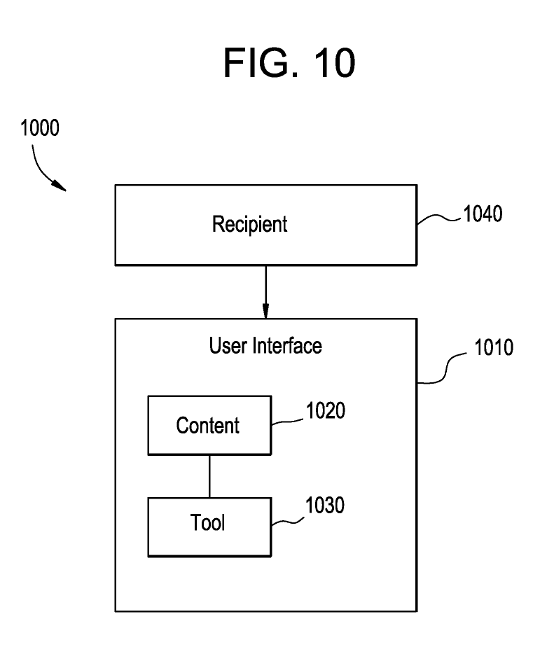

FIG. 10 illustrates an example widget system 1000 facilitating selection, holding, and transmission of one or more clinical elements from one or more applications or widgets to one or more recipients in accordance with certain embodiments of the present invention. The system 1000 includes a user interface 1010 including content 1020. The content 1020 can include applications/widgets, clinical data, links/connections to external systems/information, etc. The interface 1010 also includes and/or has a connection to a clinical element transmission unit 1030. The clinical element transmission unit 1030 receives content 1020, either via user selection and/or via automated selection using one or more rules, preferences, etc. The clinical element transmission unit 1030 can be used alone and/or in conjunction with an active listener agent, such as an active listener agent described above, for example. The clinical element transmission unit 1030 packages the selected content 1020 and transmits the content 1020 to a recipient 1040. The transmission of the selected content 1020 can include representations and/or underlying detail of clinical data element and/or other information, for example. The recipient 1040 can include one or more clinicians (e.g., clinician computers), applications/widgets, interfaces, data stores, etc. Components of the system 1000 can be implemented alone and/or in various combinations of hardware, software, and/or firmware, for example. To the extent that the system 1000 is implemented only in software, one or more of the components of the system 1000 (e.g., the user interface 1010, the content 1020, the clinical element transmission unit 1030, and/or the recipient 1040) includes machine readable instructions stored on a tangible medium. Also, any of the components of the system 1000 can be implemented by hardware such as an application specific integrated circuit (“ASIC”) and/or other logic circuit, for example.

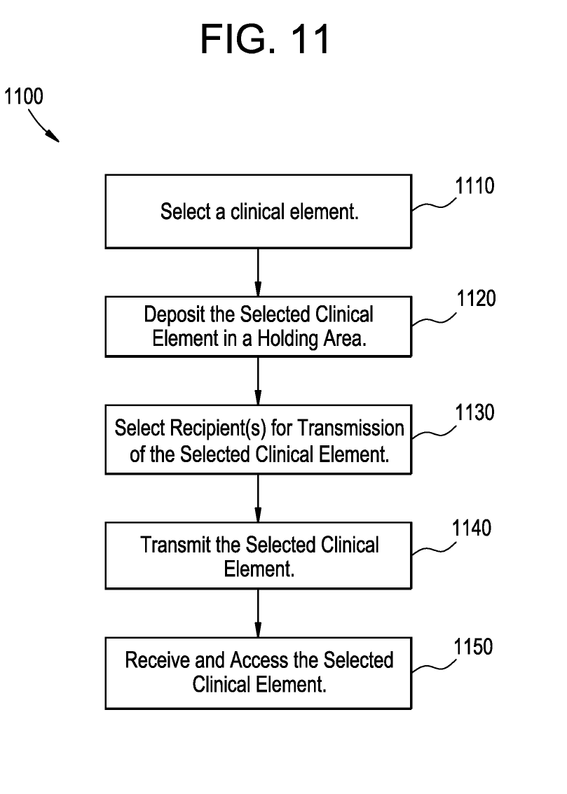

FIG. 11 illustrates a flow diagram for a method 1100 for facilitating selection, holding, and transmission of one or more clinical elements from one or more applications or widgets to one or more recipients in accordance with certain embodiments of the present invention.

At 1110, a user selects an element displayed and/or accessible via a user interface. A clinical element can represent patient information, other clinical detail, and/or a summarized representation of the detail data that is hidden behind the summary representation, for example. For example, the user can select a representation of an MR image series (e.g., the brain MR image 810 depicted in FIG. 8) from a radiology widget on the user interface.

At 1120, the user deposits the selected clinical element into a holding or temporary storage area on the user interface screen. For example, the user can drag and drop a selected clinical element, such as a representation of an MR image series, into a holding area of a user interface widget, such as a DEC widget.

At 1130, a user selects one or more recipients for transmission of the selected clinical element. For example, a user interface tool or widget allows the user to select an appropriate person or persons to email and/or otherwise transmit the information in the holding bin (e.g., the holding area 800 shown in FIG. 8). Target(s) can be specified, and additional information or detail can be provided to describe the clinical element(s) and/or other information being sent, for example.

At 1140, the selected clinical element is transmitted to the selected recipient(s). For example, the user can select “send message” via the user interface widget to transmit a message including one or more selected clinical element(s) and/or additional information to the intended recipient(s).

At 1150, a recipient receives the transmitted clinical element. When a recipient receives the message, the email and/or other transmission can include the transmitting user selected information as well as, in certain embodiments, detail information embedded into the message (e.g., information that is represented by the widget objects 805, 810, 815, shown in FIG. 8, etc.). In certain embodiments, graphical representations (e.g.; colored squares of varying sizes) that were dragged and dropped into the message are replaced with the underlying detail data. For example, as shown in FIG. 9, the email 900 sent to a recipient includes expanded detail regarding the ECG representation 805, brain MR image 810, and clinical details 815 from the holding area 800 shown in FIG. 8. The email 900 includes patient information 905, clinical detail 910, an MR image 915, and patient ECG data 920, for example. Thus, in certain embodiments, inclusion of graphical representations of clinical elements into a transmitted message results in the underlying content for those representations being included and transmitted to one or more recipients, including one or more persons authorized to view the information, an information system, an archive, an electronic medical record, etc. In certain embodiments, information from the message can be transferred to another application or interface, for example.

One or more components of the method 1100 may be implemented alone or in combination in hardware, firmware, and/or as a set of instructions in software, for example. Certain examples may be provided as a set of instructions residing on a computer-readable medium, such as a memory, hard disk, DVD, or CD, for execution on a general purpose computer or other processing device.

Certain examples may omit one or more of these steps and/or perform the steps in a different order than the order listed. For example, some steps may not be performed in certain examples. As a further example, certain steps may be performed in a different temporal order, including simultaneously, than listed above.

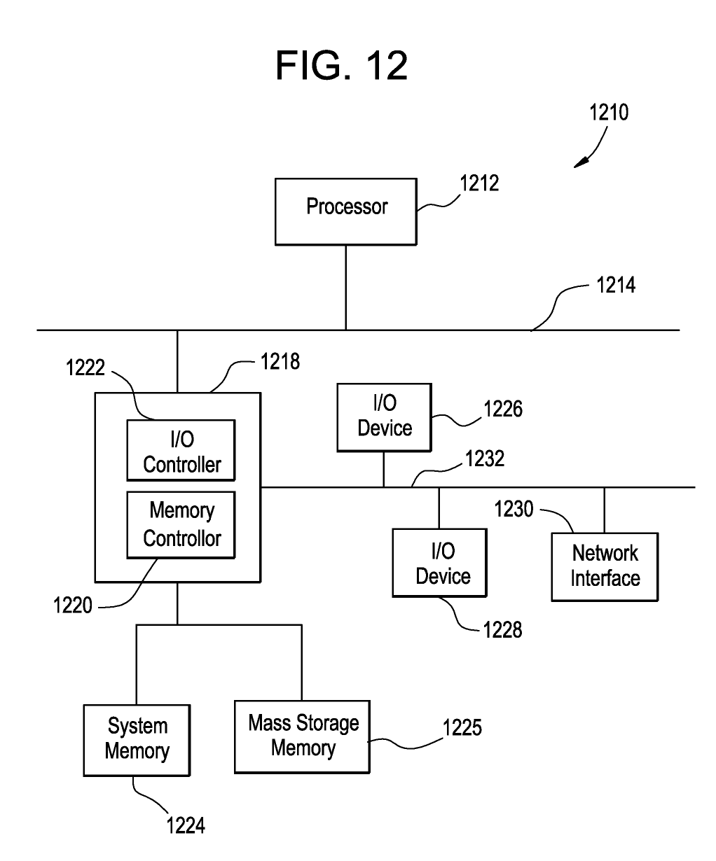

FIG. 12 is a block diagram of an example processor system 1210 that may be used to implement systems and methods described herein. As shown in FIG. 12, the processor system 1210 includes a processor 1212 that is coupled to an interconnection bus 1214. The processor 1212 may be any suitable processor, processing unit, or microprocessor, for example. Although not shown in FIG. 12, the system 1210 may be a multi-processor system and, thus, may include one or more additional processors that are identical or similar to the processor 1212 and that are communicatively coupled to the interconnection bus 1214.

The processor 1212 of FIG. 12 is coupled to a chipset 1218, which includes a memory controller 1220 and an input/output (“I/O”) controller 1222. As is well known, a chipset typically provides I/O and memory management functions as well as a plurality of general purpose and/or special purpose registers, timers, etc. that are accessible or used by one or more processors coupled to the chipset 1218. The memory controller 1220 performs functions that enable the processor 1212 (or processors if there are multiple processors) to access a system memory 1224 and a mass storage memory 1225.

The system memory 1224 may include any desired type of volatile and/or non-volatile memory such as, for example, static random access memory (SRAM), dynamic random access memory (DRAM), flash memory, read-only memory (ROM), etc. The mass storage memory 1225 may include any desired type of mass storage device including hard disk drives, optical drives, tape storage devices, etc.

The I/O controller 1222 performs functions that enable the processor 1212 to communicate with peripheral input/output (“I/O”) devices 1226 and 1228 and a network interface 1230 via an I/O bus 1232. The I/O devices 1226 and 1228 may be any desired type of I/O device such as, for example, a keyboard, a video display or monitor, a mouse, etc. The network interface 1230 may be, for example, an Ethernet device, an asynchronous transfer mode (“ATM”) device, an 802.11 device, a DSL modem, a cable modem, a cellular modem, etc. that enables the processor system 1210 to communicate with another processor system.

While the memory controller 1220 and the I/O controller 1222 are depicted in FIG. 12 as separate blocks within the chipset 1218, the functions performed by these blocks may be integrated within a single semiconductor circuit or may be implemented using two or more separate integrated circuits.

Thus, certain embodiments provide for access by an end user to information across enterprise systems. Certain embodiments provide a technical effect of a search-driven, role-based, workflow-based, and/or disease-based interface that allows the end user to access, input, and search medical information seamlessly across a healthcare network. Certain embodiments offer adaptive user interface capabilities through a work-centered interface tailored to individual needs and responsive to changes in a work domain. Certain embodiments introduce an adaptive, work-centered user interface technology software architecture, which uses an ontology modeling approach to characterize a work domain in terms of “work-centered” activities as well as computation mechanisms to achieve an implementation that supports those activities and provides adaptive interaction, both user directed and automated, in work-centered characterization and presentation mechanisms of the user interface to enterprise-level applications. Certain embodiments provide a technical effect of transferring clinical content to authorized users via a simplified, graphically-based holding area and messaging system. Certain embodiments transform graphical indicators of clinical data into a message including the underlying clinical data itself for messaging and/or transmission to another system.

Certain embodiments provide an adaptive user interface that leverages semantic technology to model domain concepts, user roles and tasks, and information relationships, for example. Semantic models enable applications to find, organize and present information to users more effectively based on contextual information about the user and task. Applications can be composed from libraries of information widgets to display multi-content and multi-media information. In addition, the framework enables users to tailor the layout of the widgets and interact with the underlying data.

Certain embodiments provide systems and methods facilitating extraction, holding, and transmission of one or more clinical elements from an application to a recipient. Certain embodiments provide a technical effect of transforming a graphical representation of clinical content in a user interface into detailed clinical content provided to a recipient via electronic message.

Certain embodiments contemplate methods, systems and computer program products on any machine-readable media to implement functionality described above. Certain embodiments may be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments of the present invention may omit one or more of the method steps and/or perform the steps in a different order than the order listed. For example, some steps may not be performed in certain embodiments of the present invention. As a further example, certain steps may be performed in a different temporal order, including simultaneously, than listed above.

Certain embodiments include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A clinical data element communicator system, said system comprising:
a user interface including clinical content retrieved from a plurality of clinical information sources for graphical display to a user, the user interface facilitating user interaction with the displayed clinical content including clinical applications and patient data;
a holding area displayed as part of the user interface, the holding area holding clinical content selected by the user and deposited in the holding area; and
a clinical element transmission unit receiving the clinical content deposited in the holding area, packaging the clinical content, and transmitting the clinical content in an electronic data message to one or more recipients.

2. The system of claim 1, further comprising an active listener agent operating in conjunction with user interface to monitor user and application activity, wherein the active listener agent automatically selects clinical content and populates the holding area based on at least one of predetermined criteria and observed usage pattern.

3. The system of claim 1, wherein the selected clinical content includes a graphical representation of underlying clinical data and wherein the clinical element transmission unit generates the electronic data message including the underlying clinical data corresponding to the graphical representation.

4. The system of claim 1, wherein the one or more recipients include at least one of a clinician electronic mail recipient, an application, and an electronic data store.

5. The system of claim 1, wherein the clinical content includes at least one of patient vital sign information, image data, a clinical report, and a clinical order.

6. The system of claim 1, further comprising a message area enabling a user to compose an electronic message for transmission in conjunction with the selected clinical content via the clinical element transmission unit

7. The system of claim 1, wherein a recipient can extract the selected clinical content from the electronic data message.

8. A method for clinical data element communication, said method comprising:
accepting user input to select clinical content retrieved from a plurality of clinical information sources and graphically displayed to a user, the displayed clinical content including clinical applications and patient data; and
temporarily storing clinical content selected by the user and deposited in a holding area displayed as part of the user interface;
generating an electronic data message including the clinical content temporarily stored from the holding area; and
transmitting the electronic data message to one or more recipients.

9. The method of claim 8, further comprising receiving the electronic data message at one of the one or more recipients and extracting the clinical content from the electronic data message for output to the recipient.

10. The method of claim 8, further comprising automatically selecting clinical content and populating the holding area based on at least one of predetermined criteria and observed usage pattern.

11. The method of claim 8, wherein the selected clinical content includes a graphical representation of underlying clinical data and wherein the clinical element transmission unit generates the electronic data message including the underlying clinical data corresponding to the graphical representation.

12. The system of claim 8, wherein the one or more recipients include at least one of a clinician electronic mail recipient, an application, and an electronic data store.

13. The method of claim 8, wherein the clinical content includes at least one of patient vital sign information, image data, a clinical report, and a clinical order.

14. A computer readable medium including a set of instructions for execution on a computer which, when executed, implement a data element communicator system, said system comprising:
a user interface including electronic data elements retrieved from a plurality of information sources for graphical display to a user, the user interface facilitating user interaction with the displayed electronic data elements;
a holding area displayed as part of the user interface, the holding area holding one or more electronic data elements selected by the user and deposited in the holding area; and
a data element transmission unit receiving the one or more electronic data elements deposited in the holding area, packaging the one or more electronic data elements, and transmitting the one or more electronic data elements in an electronic data message to one or more recipients.

15. The computer readable medium of claim 14, further comprising an active listener agent operating in conjunction with user interface to monitor user and application activity, wherein the active listener agent automatically selects one or more electronic data elements and populates the holding area based on at least one of predetermined criteria and observed usage pattern.

16. The computer readable medium of claim 14, wherein the one or more selected electronic data elements includes a graphical representation of underlying data and wherein the data element transmission unit generates the electronic data message including the underlying data corresponding to the graphical representation.

17. The computer readable medium of claim 14, wherein the one or more recipients include at least one of an electronic mail recipient, an application, and an electronic data store.

18. The computer readable medium of claim 14, wherein the one or more electronic data elements includes at least one of patient vital sign information, image data, a clinical report, and a clinical order.

19. The computer readable medium of claim 14, further comprising a message area enabling a user to compose an electronic message for transmission in conjunction with the one or more selected electronic data elements via the clinical element transmission unit

20. The computer readable medium of claim 14, wherein a recipient can extract the one or more selected electronic data elements from the electronic data message.
